(19) United States
(12) Patent Application Publication
(10) Pub. No.: US 2026/0194036 A1
(43) Pub. Date: Jul. 9, 2026

(54) HYDRO-TURBINE AND ITS DEPLOYMENT

(71) Applicant: REPETITIVE ENERGY COMPANY LIMITED, Pembroke Dock, Dyfed (GB)

(72) Inventors: Ryan XUEREB, Pembroke Dock, Dyfed (GB); Francis William MOLONEY, Pembroke Dock, Dyfed (GB); Gregory Malcolm CASELEY, Pembroke Dock, Dyfed (GB)

(21) Appl. No.: 19/132,804

(22) PCT Filed: Nov. 22, 2023
(86) PCT No.: PCT/IB2023/061786

§ 371 Date: May 24, 2025

(30) Foreign Application Priority Data
Nov. 24, 2022 (GB) 2217568.1
Jul. 5, 2023 (GB) 2310337.7

(51) Int. Cl. F03B 17/06; F03B 13/26

(52) U.S. Cl. CPC F03B 17/063; F03B 13/264; F05B 2210/404; F05B 2240/244; F05B 2250/315; F05B 2260/04

(57) ABSTRACT

Disclosed is a cross axis hydro-turbine arrangement for capturing energy from a water flow W, the arrangement including a turbine, a drive shaft, a machine for converting rotational energy of the shaft into other energy, a support frame, a support beam and a pivot arrangement, wherein, the turbine is arranged to drive the shaft in rotation, the shaft is arranged to drive, directly or indirectly, the machine, the turbine and machine are mounted on the support frame, and the frame is pivotable on the pivot about the beam.

### FIELD OF THE INVENTION

The present invention relates to turbines for harnessing the kinetic energy in water flows, particularly but not exclusively, vertical axis hydro-turbines i.e. where the axis of rotation of the turbine is nominally perpendicular/transverse to the water flow, also known as cross-axis turbines, and to the deployment of such turbines.

### BACKGROUND OF THE INVENTION

Numerous attempts have been made to harness water flow as a source of energy. Horizontal axis water mills were one of the first means of powering industrial machinery. Undershot and overshot wheels have been employed for centuries. Historic screw type turbines have been invented also. Such early designs lacked efficiency and reliability.

Reaction turbines, such as a Pelton wheels, which employ a jet or jets of water have been used to improve efficiency. Impulse wheels, such as Francis and Kaplan wheels have also been produced, with further improved efficiency. These impulse wheels generally have an enclosed bladed turbine set of various geometries. However, these designs rely on complex sets of turbine blades and complementary curved/scrolled housings, which are expensive to manufacture, and not easy to repair because they are enclosed. Where it is impracticable to capture water flows in pipes and the like, for example in tidal sea flows or deep rivers or canals, such reaction and impulse type designs are impracticable. Francis rotors and Kaplan rotors are examples of turbine rotors that rotate about an axis that is aligned with the overall direction of the fluid flowing through them. Savonius rotors and Darrieus rotors are examples of turbine rotors that rotate about an axis that is transverse with the overall direction of the fluid flowing through them, but which do not necessarily require enclosure. Embodiments of this invention relate to these latter turbine types, which are also called vertical axis turbines or cross axis turbines.

Where tidal flows are harnessed, it is quite possible that for some of the time, only a part of the turbine will be submerged, and the flow will reverse with the rise and ebb of the tide. So enclosed turbines will be of no use, unless a significant superstructure is constructed to channel water flow at most stages of a tide. One example of such a superstructure is disclosed in GB2495443 which shows a vertical/cross axis turbine arrangement combined with a barrage and water channels.

Various other vertical axis tidal flow turbines have been considered, without the need for such a superstructure but these known designs are weak and/or complicated. Such designs are disclosed, for example in CA2849054; KR20130096060; and WO2013030582.

Where turbines are intended for commercial use in remote or inaccessible areas, such as deep under water or in strong tidal flows, then low cost, ease of deployment and installation, and reliability, are the most important factors. Efficiency is important but is secondary. So a water channelling superstructure is too expensive in most cases, unless they have another use, such as a water dam or a vehicle bridge. Enclosed turbines are also expensive and difficult to repair, particularly under water.

The inventors have realised that a simple, strong, and self-contained turbine can mitigate some of the drawbacks of previous designs. The present Applicant's patent U.S. Pat. No. 10,746,155 relates to such an improved turbine, and the disclosure therein is incorporated by reference herein. Additionally, the inventors have disclosed herein design efficiency improvements to the turbine disclosed in U.S. Pat. No. 10,746,155 and also improvements in relation to the ease of deployment of such turbines.

The invention provides a water flow turbine arrangement for capturing energy from the water flow according to the claims herein having preferred features defined by dependent claims. According to one aspect the invention provides a cross axis hydro-turbine arrangement for capturing energy from a water flow, the arrangement including a turbine, a drive shaft, a machine for converting rotational energy of the shaft into other energy, a support frame, a support beam and a pivot arrangement, wherein, the turbine is arranged to drive the shaft in rotation, the shaft is arranged to drive, directly or indirectly, the machine, the turbine and machine are mounted on the support frame, and the frame is pivotable on the pivot about the beam.

Optionally, the pivot arrangement is approximately at the centre of gravity of the support frame, the turbine being at one side of the pivot, and the machine being at the other side of the pivot.

The support frame may further include a counterweight in the form of a fluid tank.

Optionally, the arrangement may include a fluid pump to add or remove fluid to or from the tank, thereby to change the mass of the counterweight, and to cause said pivoting.

Optionally, the frame is inhibited from pivoting under the influence of water flow by means of a tension member, for example a cable, either holding a lower part of the frame from an upstream direction, or holding an upper part of the frame from downstream direction.

Optionally, the tension member is anchored by means of fluid tanks.

Optionally, the tension member is capable of releasing said holding when tensioned beyond a predefined load.

The invention extends to any combination of features disclosed herein, whether or not such a combination is mentioned explicitly herein. Further, where two or more features are mentioned in combination, it is intended that such features may be claimed separately without extending the scope of the invention.

### BRIEF DESCRIPTION OF THE DRAWINGS

The invention can be put into effect in numerous ways, illustrative embodiments of which are described below with reference to the drawings, wherein:

FIG. 1 shows schematically a pictorial view of one embodiment of a vertical axis turbine;

FIG. 2 shows a detail of the turbine shown in FIG. 1;

FIG. 3 shows a pictorial view of a second embodiment of a vertical axis turbine;

FIG. 4 shows a side view of the turbine shown in FIG. 3;

FIG. 5 shows a plan view of the turbine shown in FIG. 3 ;.

FIG. 6 shows an exploded view of the turbine shown in FIG. 3;

FIG. 7 shows details of the turbine shown in FIG. 3;

FIG. 8 shows a pictorial view of a vertical axis turbine according to a third embodiment;

FIG. 9 shows an arrangement employing the turbine of FIG. 8 in a water channel;

FIG. 10 shows a plan view of the arrangement shown in FIG. 9;

FIG. 11 shows a side view of the arrangement shown in FIG. 9;

FIG. 12 shows an end view of the arrangement shown in FIG. 9;

FIG. 13 shows a detailed pictorial view of elements of the arrangement shown in FIG. 9; and

FIGS. 14,15 and 16 show an alternative arrangement of a water channel deployment.

### DETAILED DESCRIPTION OF THE INVENTION

The invention, together with its objects and the advantages thereof, may be understood better by reference to the following description in conjunction with the accompanying drawings, in which like reference numerals identify like elements in the Figures.

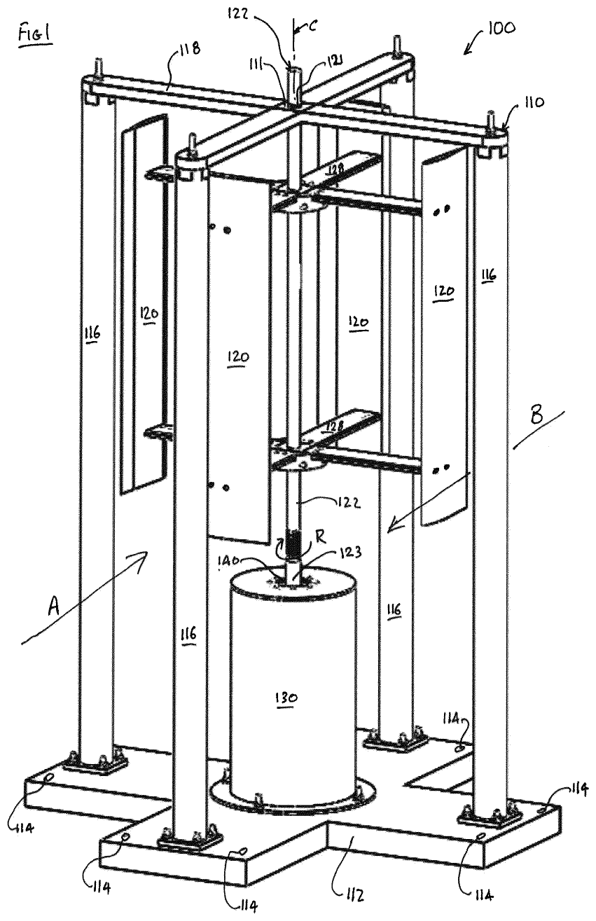

Referring to FIG. 1, an embodiment of a cross axis turbine 100 is shown schematically, which includes a fixed superstructure 110, a set of blades 125 mounted on a drive shaft 122 and a rotary machine 130, in this case in the form of an electrical generator, coupled to the drive shaft 122, and fixed to a base 112 of the superstructure 110. This turbine allows generation of electric power from water flows in any approach direction, for example tidal flow and ebb in the directions A and B respectively.

In more detail, the base 112 of the superstructure 110 is manufactured from cast concrete and steel which is preferably heavy enough to hold down the whole turbine 100 to the bed of the water volume in strong water currents. The base 112 is provided with anchor points 114 also, should the water currents at the deployment area merit securing of the turbine to the bed. The superstructure further includes four support legs 116 which are rigidly secured to, and are upstanding from, the base 112. At their upper ends, the legs are further rigidified by, a demountable cross brace 118, having a central top bearing 111 within which an upper end 121 of the turbine's drive shaft 122 rotates in use.

The blade set 125 comprises four equally spaced blades 120 connected adjacent their upper and lower regions to the drive shaft 122 by respective spokes 128. The blades 120 are straight along their length and parallel to each other which allows a simple low cost construction. The blades each have lift type profiles, which pull the blade around into the water flow, in the direction of arrow R, and offer low resistance to rotation when moving with the flow.

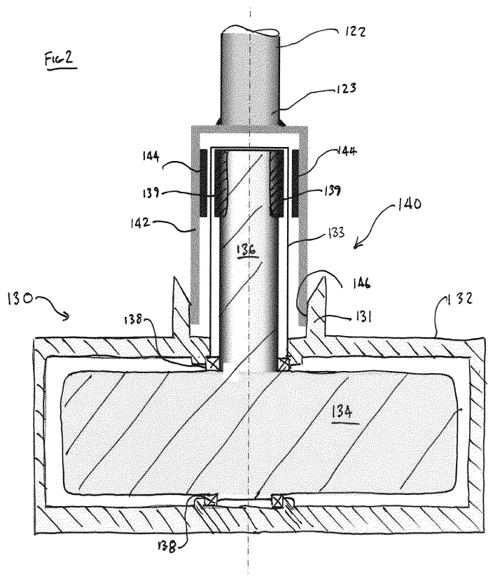

At the lower end 123 of the drive shaft 122, is a coupling 140 for transmitting torque to the generator 130 as the shaft is rotated by the blades 120 in a water flow. This coupling 140 is shown in FIG. 2.

FIG. 2 shows a cross section through the coupling 140 between the drive shaft 122 and the generator 130. The coupling 140 includes a bell housing 142 which is attached to the lower end of the shaft 123 for rotation therewith. An inner face of the bell housing includes a cylindrical array of powerful permanent drive magnets 144. The lower end 146 of the bell housing 142 fits snugly in an open mouthed receiving socket 131 in an upper face of the generator's housing 132, such 10 that the housing acts as a bearing support to keep the generator 130 and shaft 122 aligned by acting as a rotary bearing. Other bearing arrangements are possible to achieve the same alignment. The generator 130 has a rotor 134, driven by a driven shaft 136 all supported on bearings 138, and all hermetically sealed within the generator housing 132. The top of the driven shaft 136 further includes a cylindrical array of powerful permanent driven magnets 139 which are positioned in a complementary attracted position to the drive magnets 144 inside the bell housing 142, such that rotation of the shaft 122 causes rotation of the driven shaft 134 in a torque transmitting manner, as a result of magnetic attraction between the magnets 144 and 139. The housing 132 includes a thin nonmagnetic stainless steel sleeve 133, fitted between the complementary magnets, over the driven shaft 134, forming part of the housing, such that the hermetic sealing of the housing 132 is maintained. Since the generator is hermetically sealed, then there is no possibility of water ingress into the generator housing. The permanent magnet parts and their mountings which form part of the coupling 140 and available commercially for example from KTR Couplings Ltd under the trade name Minex.

This coupling arrangement allows upper parts of the superstructure 110, i.e. the cross brace 118 shown in FIG. 1 to be disengaged from lower parts of the superstructure 110, i.e. the legs 116, and to be lifted together with the shaft 122 and blade assembly 125, and to leave the generator 130 in place fixed to the base 112, for maintenance purposes. The generator can then be removed if required. Each can be replaced with easy reassembly.

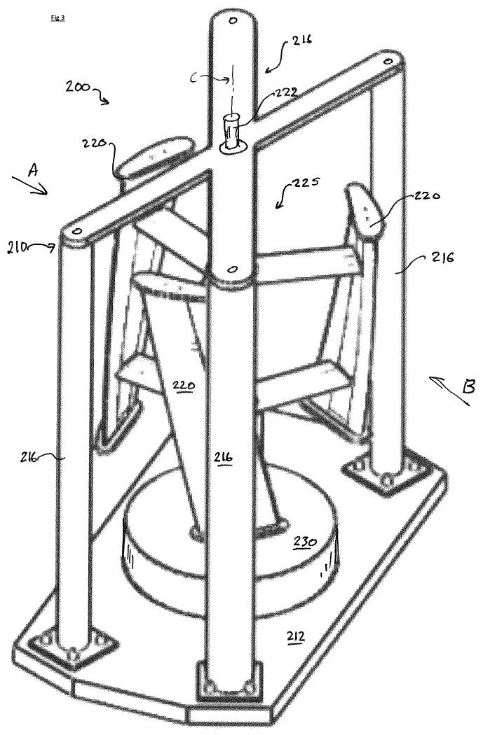

FIG. 3 shows a further embodiment of a turbine 200 which is similar in construction to the turbine 100 described above. Parts which are similar in construction in the embodiment shown in FIG. 1 and in the embodiment shown in FIG. 3 have the same last two digits in their reference numbers and so are not fully described below.

The embodiment shown in FIG. 3 includes a base 212 and legs 216, which have broadly the same construction and function as the base 112 and legs 116 described above, but the legs are not equidistantly spaced in this embodiment. Rather, the legs are laid out such that they occupy a generally rectangular plan, and so are positioned to avoid perturbing water flow in the A and B directions, which are the most likely flow directions which may be encountered when tidal flows are reversed by 180 degrees.

Further, blades 220 of a blade set 225 are helically formed around a shaft 222, to provide less vibration than the straight blades shown in FIG. 1 when they rotate. In view of their helical formation, and greater efficiency, only three blades are required in this embodiment. Of note also is the proportions of the rotary machine-generator 230, which is flatter than the generator 130 illustrated in FIG. 1 and thereby provides a more compact turbine 200.

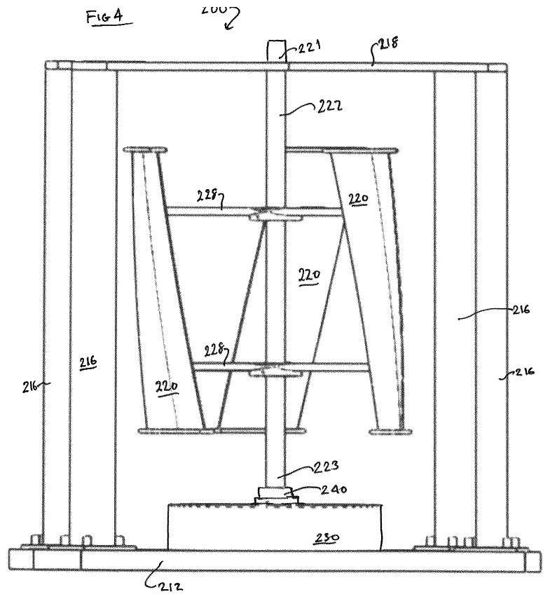

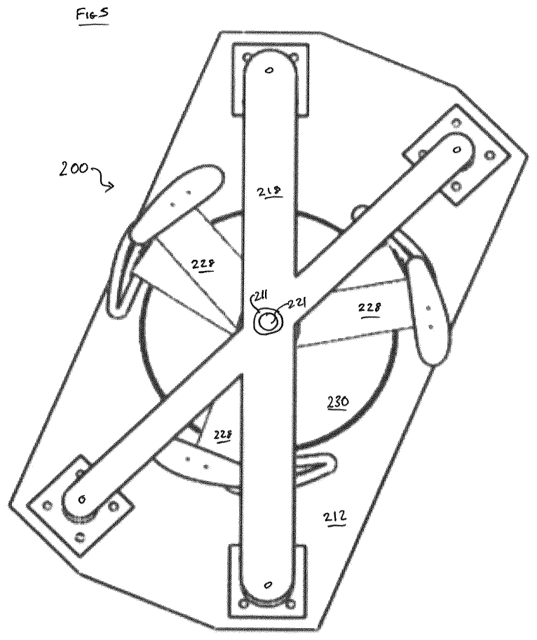

FIGS. 4 and 5 show additional views of the embodiment shown in FIG. 3. A torque transmitting coupling 240 is used, which has the same construction and function as the coupling 140 described above and illustrated in FIG. 2.

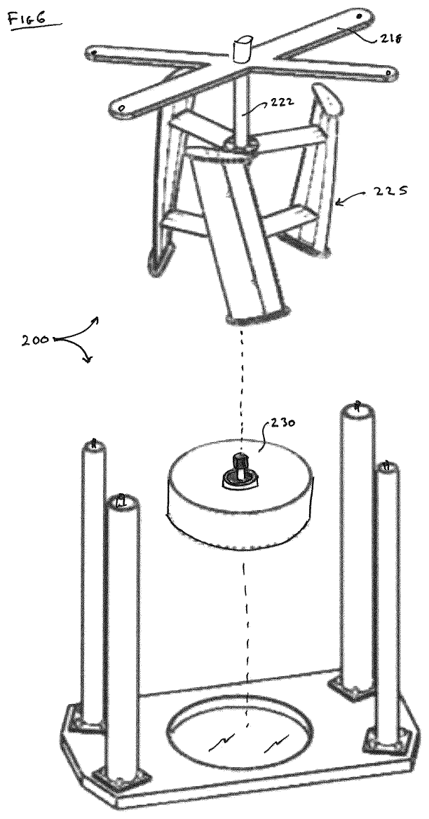

FIG. 6 shows an exploded view of the turbine 200, and illustrates that the cross brace 218, drive shaft 222 and blade set 225 can be removed for maintenance as one assembly, and can be readily separated from the remaining parts of the turbine, including the generator 230, as described above. The generator 230, in this case sits in a recess 213 in the base 212, for ease of assembly, for example when under water.

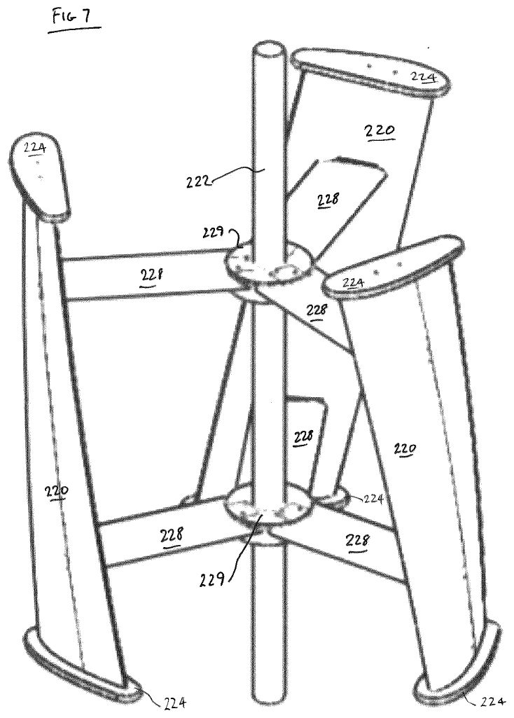

FIG. 7 shows the blade assembly 225 mounted to the drive shaft 222. The spokes 228 which support the blades 220 are each mounted to one of two spaced bosses 229, in turn mounted to the shaft 222. The spokes have an aerofoil profile to reduce drag. Each end of each blade 220 is terminated by an enlarged tip, in this case, in the form of winglet 224, which is generally flat with an aerofoil profile. These winglets 224 improve the efficiency of the helical blades still further by inhibiting water flowing over the blades to spill over their ends.

Although two embodiments have been described and illustrated above, additions, omissions and modifications are possible to those. For example, in the two embodiments, four legs 116/216 have been illustrated. Although this arrangement is preferred, to provide a generally open structure through which water can flow omnidirectionally, other numbers of legs can be employed, for example, 3 or 6 legs could be used.

A heavy base member 112/212 is preferred, but may be replaced with a lighter base member where the base can be securely anchored to the bed of the volume of water in which the turbine 100/200 rests. The rotary machine 130/230 disposed below the blade assembly 125/225, increases the effective weight of the base and so increases the stabilising effect of the base. To increase weight further, the rotary machine may include a gearbox to increase the rotational speed of the drive. It is preferred that the gearbox be incorporated into the housing 132 of the rotary machine such that the coupling 140/240 is between the shaft 122 and the gearbox. A turbine brake can be incorporated into the rotary machine, for example at the gearbox.

A cross brace 118/218 is shown which connects together all the legs illustrated. This arrangement is preferred for rigidity, but the cross brace could have another shape besides an X shape, for example, the cross brace could be an annular ring or rectilinear frame connecting each leg, and may include one or more members extending diametrically across the ring or frame, to support the shaft 122/222.

The overall arrangement of the blade assemblies 125 and 225 mounted on a shaft 122 and 222 respectively, about a central rotational axis (C in FIGS. 1 and 3), with support legs 116 and 216 located wholly or substantially outside the swept volume of the blade assemblies defining an open superstructure. This arrangement means that no central support, for example within the shaft 30, is required. This simplifies construction and maintenance procedures, because assembly and disassembly are much easier. Also, this arrangement makes the turbine more rigid and therefore it can be made lighter. This in turn means that smaller equipment can be used to install and maintain the turbine. In addition, for the turbine 100, the legs 116, can be positioned as shown in FIG. 1, in the expected flow (A, B FIG. 1) such that they perturb water flow at the point where maximum torque would otherwise have been developed for a blade 120. Whilst some efficiency is lost as a result, the turbine100 develops less vibration during rotation, which extends turbine life. The turbine 200, having helically formed blades 220, develops lees vibration in use and so the legs 216 have been spaced so that they are outside the expected water flow path (A, B FIG. 3). Although the legs 116 and 216 have been illustrated in an arrangement which is generally equidistant and symmetrical about the rotational axis of the turbine, it is possible that the legs are not all so arranged. For example one or more legs may be closer to the rotational axis than others. In that case the legs closer to the axis can interrupt water flow to one side of the axis, where unidirectional flow is encountered in order to perturb flow on one side only in the path of the turbine elements, and thereby reducing the drag of a blade turbine element as moves in the direction of the flow, or reducing the drag of a vane turbine element as it moves into the flow.

Although rotary machines in the form of electrical generators 130/230 have been described above and illustrated, other rotary machines could be employed to turn the rotational power from the blade set into other energy or potential energy. For example, a dynamo could be used to generate electricity or a pump could be used to compress ambient water or air from a surface supply. For efficiency, blades are preferred, i.e. turbine elements which generate lift in a similar manner to an aeroplane wing, when fluid flows across them. However, vanes could be used as turbine elements, which are pushed by water flow in the same way as a conventional paddled undershot water wheel.

The embodiments provide a simple, low cost, reliable, easy to maintain turbine which can be deployed in the adverse conditions encountered in near-shore sea beds including sea beds which are exposed or have shallow water at low tides, in deeper sea beds where currents exist, and in inland waterways. Given the generally cuboid outside dimensions of the turbine constructions illustrated, it is possible to arrange plural similar turbines in a row or in a two or three dimensional array, for increased energy output. Such plural turbines can be bolted together or may have other complementary connecting means, such as hooked parts and hook receiving parts.

The above-mentioned turbines are generally known from the disclosure in U.S. Pat. No. 10,746,155, however it has been found that a blade profile the same or similar to that known as NACA0018 and a maximum chord thickness of 12-25 mm works particularly well in the arrangements described above and below. For the helically formed blades shown in FIG. 3, a helix angle of around 10 to 20 degrees, preferably about 15 degrees, measured between vertical and the blade leading edge, provides good utility. In particular, at 1.15 m/s water flow rate and a tip speed ratio of about 2, a coefficient of performance Cp of about 0.4(40 %) was achieved.

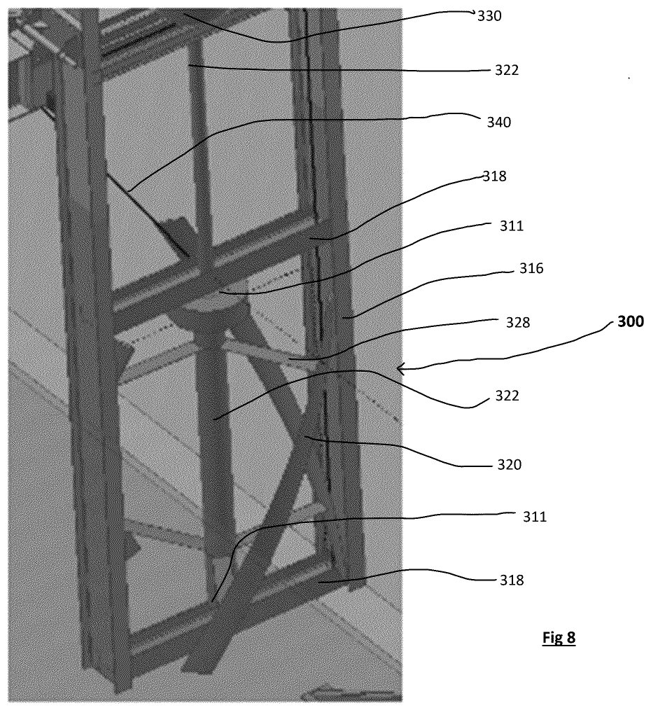

FIGS. 8 to 13 illustrate an alternative arrangement for mounting a hydro-turbine 300 of particular merit for deploying in water channels and rivers. The hydro-turbine 300 can be of the general type described above in relation to FIGS. 1 to 7, but mounted to a different frame. In the embodiment shown in FIG. 8, the body of the turbine, 300 has three helically formed lift blades 320 each mounted to a rotatable central shaft 322 via spokes 328 similar to the arrangement described above in regard to FIGS. 1 to 7.

Here, the turbine is rotatably mounted on a pair of bearings 311, one atop, and one below the turbine 300 the bearings 311 being supported on cross braces 318, in turn held in a support frame 316. The support frame 316 also supports, in this case, a generator 330, driven directly by the turbine shaft 322 extending upwardly to the generator 330.

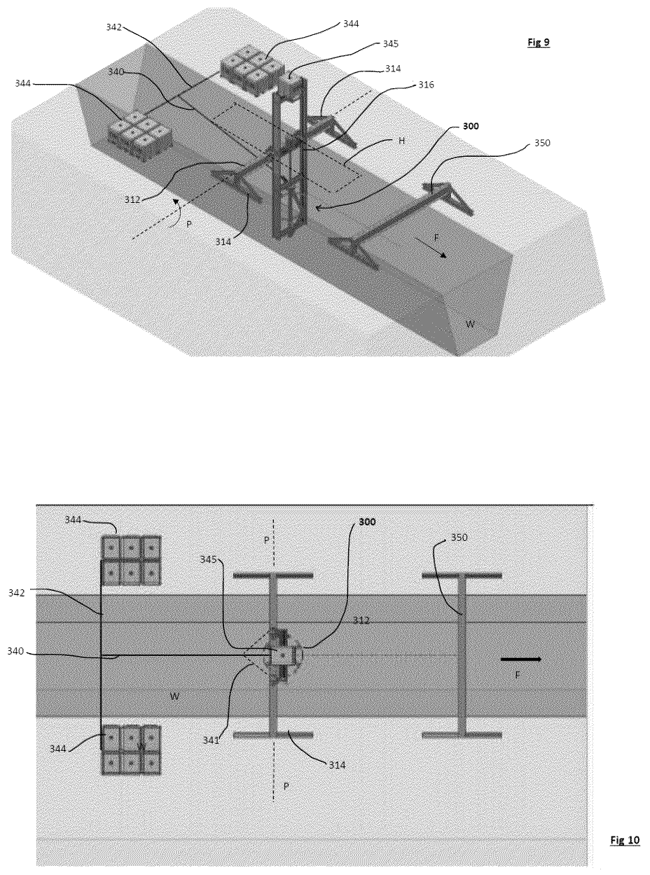

FIG. 9 shows the components mentioned immediately above deployed in a watercourse W having a water flow in the direction of arrow F. The support frame 316 is pivotable about an, approximately, mid point of the support 316 about a pivot axis P such that the turbine 300 can be pivoted out of the water W, i.e. to the point where the frame 316 lies approximately horizontal at position H. The frame 316 etc is supported on a beam 312 which has stabilising legs 314 resting on the banks of the watercourse W.

The force exerted on the turbine 300 and submerged frame 316/318 by the flow of water F will urge those parts in the direction of the flow F and cause those parts to want to pivot about axis P. That force is resisted by a tension member, in this case a cable 340 attached at one end to the upper cross brace 318, via a link 341, and at the other end to a stay 342, in turn attached to a large mass, balanced on each side of the watercourse W. In this case the large mass is a plurality of water tanks 344, filled with water, for example, obtained from the watercourse, and pumped into the tanks 344.

In order to maintain the turbine 300, it will be necessary to lift it from the watercourse W. That can be achieved by pivoting the turbine 300 on the frame 316 about the axis P. When necessary, an ancillary water tank 345 can be filled with water from the watercourse, for example by pumping water via a filler pipe into the tank 345 by means of an electric or hand pump. The weight of the water in the tank 345 will act as a counterweight allowing said pivoting to take place, once the cable 340 is slackened. Slackening of the cable 340 can be achieved by slackening the stay able 342 from the bank of the watercourse. To some extent, the force of the flowing water F, if it is flowing, will initiate the pivoting of the turbine 300 etc, and the counterweight of the water tank 345 will complete the pivoting allowing the turbine to be lifted clear of the water, and accessed via platform 350 to which the now horizontal frame 316 can be held so it can be worked on.

In a refinement, the link 341, or a further link on the cable stay 342, can be made to release or break at a predefined tension force, such that should the turbine fail, or become blocked, for example with a floating tree or the like which causes the blockage or partial blockage of the watercourse and subsequent rise in tension/in the cable 340, then the link 341, or other link will release under the increased tension brought about by said blockage. Even if the counterweight 345 is not full, the turbine will at least partially pivot to allow a less impeded water flow, until the turbine can be cleared or fixed. An intermediate position, where the turbine is not vertical and not horizontal, mat allow self-clearing of any debris, by the action of the water flow itself.

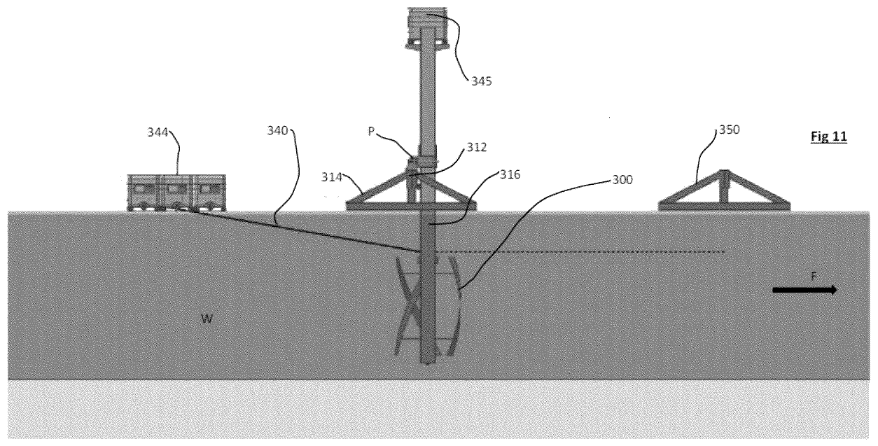

FIGS. 10 to 13 show the features mentioned above in more detail.

In particular, FIG. 10 is a plan view of the arrangement shown in FIG. 9, where the layout of the parts described above can be seen more clearly. And, looking in plan view, it will be apparent that it is possible to reverse the arrangement shown in FIGS. 9 and 10, i.e. to have the mass 344 on the downstream side of the turbine with the cable 340 running from the repositioned masses 344 to the top of the frame above the pivot axis P thereby preventing pivoting as a result of flow F forces. From this view it is also clear that the turbine 300 is exposed to debris in the water flow, and so, in a refinement, a cage may be fitted, at least across the front of the turbine. Either a half round cage could be used, or for economy, a flat faced cage 341 having a point at a leading edge and two flat faces, could be used forming a wedge facing into the flow.

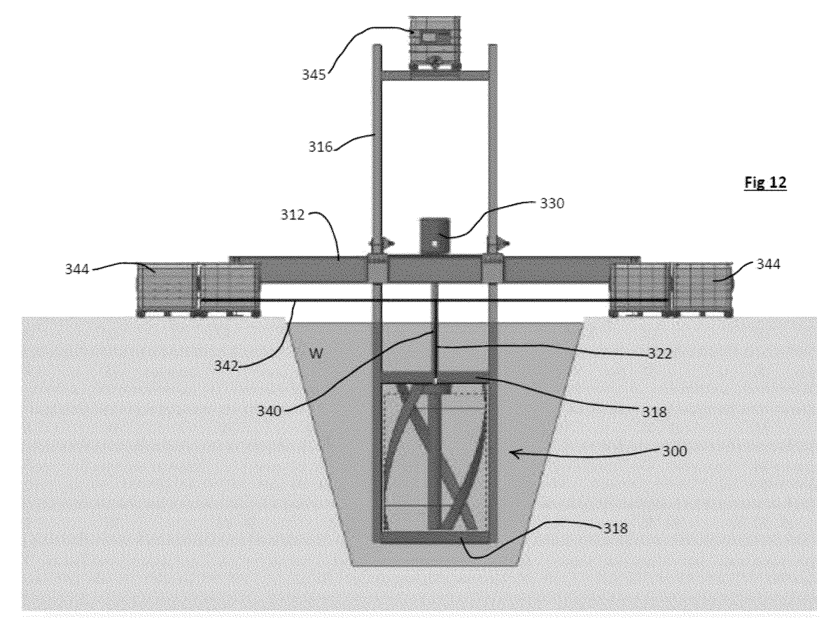

FIG. 11 is a side view showing the turbine 300 immersed in the water W. In a refinement the turbine and it's supporting subframe may be slidably mounted in the support frame 316 so that the turbine 300 can be raised and lowered in the direction of arrows R to find the maximum flow speed of water which is usually just below the water's surface. Further being able to immersing the turbine about 0.5-1.0 metre below the water's surface avoids floating debris. A pulley system could be employed for this purpose.

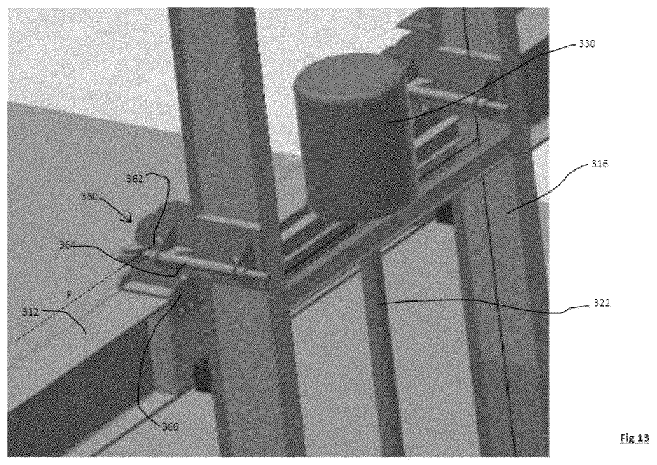

FIG. 12 is a view of the above mentioned arrangement view from upstream. The position of the generator 330 is clear to see in this figure, mounted at the top end of the rotor shaft 322. It could be positioned higher with a longer shaft, to reduce the need for as much counterweight 345 when the pivoting mentioned above is required.

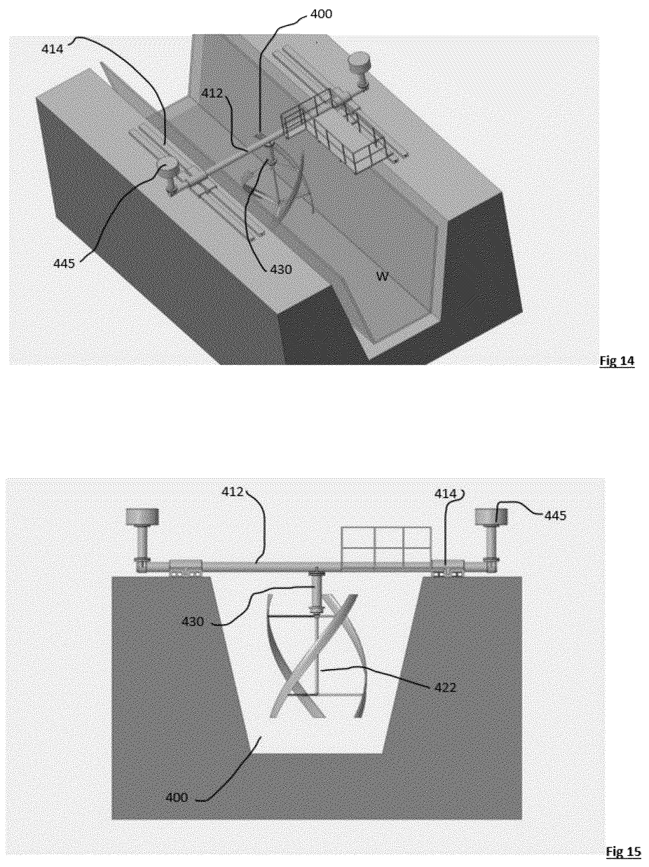

FIG. 13 is an enlarged view the pivot part of the arrangement. The generator 330, turbine support frame 316 and bridging beam 312 are described above. Additionally a pair of pivot blocks 360 are employed each having a pivot pin 362 (only one of which is visible in this figure). The pivot pins are in alignment with the pivot axis P, and allow the pivoting under the conditions described above. The pivot blocks 360 include a latch 364 in the form of a sprung wheel, which in pivoting operation rides over a striker plate 366 welded to the pivot block 360 when the frame 316 reaches the horizontal position, and preventing return movement of the frame until the latch is released.

In a refinement, the two pivot blocks 360 can moveable along the beam 312 in a direction along the pivot axis P. Actuation of that movement, for example by means of an electric or hand operated winch brings the frame 316 and turbine 300 closer to one side of the watercourse W, for example to take advantage of a faster flow of water to one side of the watercourse, or for maintenance purposes, whereby the turbine becomes more accessible from the side of the water and is convenient to maintain once it has been pivoted into a horizontal position H as described above. In view of the loads exerted by the water flow forces, it is envisaged that the frame 316 etc will be pivoted to the horizontal H position before the frame assembly is moved along the beam 312, although that need not be the case where the flow F is not so fast.

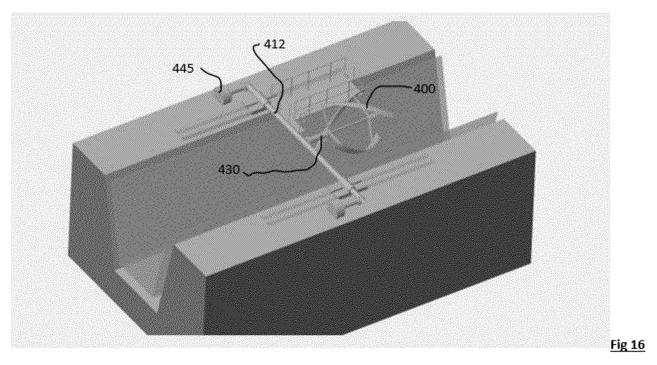

FIGS. 14,15 and 16 show a turbine 400 similar to the turbine 300 described above, deployed using an alternative pivoting frame, but which functions is a similar manner to the pivoting frame shown in FIGS. 9 to 13. In FIGS. 14-16, parts having a similar function to those shown in FIGS. 9-13 have the same last two digits in their reference numerals.

FIGS. 14 and 15 show a turbine 400 supported on a central shaft (422 FIG. 15) all rotatable to rotate the rotor of a generator 430, arranged such that the generator casing is fixed and supports the turbine 400 during rotation and power generation. In turn, the generator casing is fixed to a pivoting beam 412, which can pivot in use about ground supports 414. The ground supports 414 hold the beam 412 in place in normal use so that the turbine is in the watercourse W. When maintenance is required, pins through the beam preventing beam rotation can be released, thereby allowing rotation of the turbine upwardly, aided by counterweights 445. That rotated position is shown in FIG. 16. The pins can be of a size that break, when the turbine becomes overburdened, such that the turbine will pivot freely to avoid damage. Other means to prevent the beam rotation and allow pivoting during overload could be used, for example sprung detents, friction elements, or the cables mentioned previously. The counterweights 445, may liquid fillable as mentioned previously so their weight can be adjusted.

1. A cross axis hydro-turbine arrangement for capturing energy from a water flow, the arrangement including a turbine a drive shaft, a machine for converting rotational energy of the shaft into other energy, a support frame a support beam and a pivot arrangement wherein, the turbine is arranged to drive the shaft in rotation, the shaft is arranged to drive, directly or indirectly, the machine the turbine and machine are mounted on the support frame and the frame is pivotable on the pivot about the beam.

2. The arrangement claimed in claim 1, wherein the pivot arrangement is approximately at the centre of gravity of the support frame, the turbine being at one side of the pivot, and the machine being at the other side of the pivot.

3. The arrangement claimed in claim 2, wherein the support frame further includes a counterweight in the form of a fluid tank.

4. The arrangement claimed in claim 3, including a fluid pump to add or remove fluid to or from the tank, thereby to change the mass of the counterweight, and to cause said pivoting.

5. The arrangement claimed in claim 1 wherein the frame is inhibited from pivoting under the influence of water flow by means of a tension member, for example a cable, either holding a lower part of the frame from an upstream direction, or holding an upper part of the frame from downstream direction.

6. The arrangement claimed in claim 5, wherein the tension member is anchored by means of fluid tanks.

7. The arrangement claimed in claim 5 wherein said tension member is capable of releasing said holding when tensioned beyond a predefined load.

8. A cross axis hydro-turbine arrangement for capturing energy from a water flow, the arrangement including a turbine a drive shaft a machine for converting rotational energy of the shaft into other energy, and a support beam, wherein the turbine is arranged to drive the shaft in rotation, the shaft is arranged to drive, directly or indirectly, the machine the turbine and machine are mounted on the beam, and the beam is pivotable.
